(19) United States
(12) Patent Application Publication
(10) Pub. No.: US 2007/0056262 A1
(43) Pub. Date: Mar. 15, 2007

(54) Laser propulsion thruster

(76) Inventors: Rachel Leach, LITTLETON, CO (US); Gerald Bernard Murphy, Conifer, CO (US); Thomas Seton Adams, Littleton, CO (US)

Correspondence Address: LATHROP & GAGE LC, 4845 PEARL EAST CIRCLE, SUITE 300, BOULDER, CO, 80301, US

(21) Appl. No.: 10/561,294

(22) PCT Filed: Jun. 25, 2004
(86) PCT No.: PCT/US04/20226

§ 371 Date: Dec. 20, 2005

Related U.S. Application Data
(60) Provisional application No. 60/482,601, filed on Jun. 25, 2003.

(51) Int. Cl. B64G 1/40; F02K 9/68

(52) U.S. Cl. 60/204; 60/200.1

(57) ABSTRACT

A hybrid electric-laser propulsion (HELP) thruster. A propellant has self-regenerative surface morphology. A laser ablates the propellant to create an ionized exhaust plasma that is non-interfering with a trajectory path of expelled ions. An electromagnetic field generator generates an electromagnetic field that defines a thrust vector for the exhaust plasma. Multiple HELP thrusters may be ganged together, and controlled, according to mission criteria.

### RELATED APPLICATION

This is a nonprovisional. application of U.S. Letters Patent Ser. No. 60/482,601 entitled HYBRID ELECTRIC-LASER PROPULSION SYSTEM AND ASSOCIATED METHODS the aforementioned application is incorporated herein by reference thereto.

### BACKGROUND

The increasing demand in science and military applications for precision orbital positioning and formation flying platforms has created a need for enabling thruster technologies.

Electric and laser-type thrusters are micro-propulsion technologies that convert electric/laser energy into exhaust kinetic energy, to generate a force (“thrust”). Various forms of electric-type thrusters (e.g., Pulsed Plasma Thrusters (PPT), Hall thrusters, Field Emission Electric Propulsion (FEEP) and Colloid thrusters) have been researched since the early 1950's, while laser-type thrusters for use in space applications has been researched since the early 1970's. Major limiting factors in these thrusters include poor repeatability, inefficiency in propellant and power usage, low specific impulse (Iₛₚ), high noise level at minimum impulse bit (MIB), poor component lifetimes, contamination, and the inability to operate in a continuous (i.e., low noise) operating mode. Additionally, certain of these thrusters have unacceptably high overhead mass, are susceptible to valve wear and leakage, and employ propellants that are toxic or provide on-orbit contamination. Prior art thrusters also require complex subsystem components that are difficult to integrate into a small bus structure.

Performance inefficiency is also of concern for current thrusters. For example, the ion beam profiles of prior art electric- and laser-type thrusters have recorded divergence angles varying between approximately ±13 and ±50 degrees, which corresponds to a performance reduction of as much as 36%, as illustrated by the graph 2 of FIG. 1. In FIG. 1, x-axis 4 corresponds to the total beam angle divergence (i.e., angle from central emission axis) that emitted ions are distributed over for a prior art thruster as a function of emission currents (y-axis 6).

Patents illustrative of prior art thrusters include: U.S. Pat. No. 6,530,212, to C. R. Phipps et al., entitled “Laser Plasma Thruster”; U.S. Pat. No. 4,866,929, to S. Knowles et al., entitled “Hybrid Electrothermal/Electromagnetic Arcjet Thruster and Thrust Producing Method”; U.S. Pat. No. 5,170,623, to C. L. Dailey et al., entitled “Hybrid Chemical/Electromagnetic Propulsion System”; and U.S. Pat. No. 6,318,069, to L. R. Falce et al., entitled “Ion Thruster having grids made of oriented Pyrolytic Graphite”, each of which is incorporated herein by reference.

### SUMMARY OF THE INVENTION

An embodiment hereof overcomes certain issues of the prior art by employing electromagnetic coils that generate an electromagnetic field to control and focus the velocity distribution of an exhaust plasma. As compared to the prior art, such an embodiment may for example improve the achievable thruster performance (in particular specific impulse and thrust) and also minimize contamination and undesirable cross-coupling effects.

In one embodiment, a thruster constructed according to the teachings herein provides high efficiency, low noise, ‘tunable’ micro- to milli-Newton thrust range propulsion that may be utilized within low and high-Earth orbital platforms, including those with masses and missions of large satellites and small satellites. In certain embodiments, the thruster may be employed to achieve certain capabilities, such as, for example: fine impulse control, high specific impulse, low noise, high mission ΔV, maximum thrust for minimum power, minimum contamination and maximum lifetime. In certain embodiments, the thruster may also be configured to provide satellite interfaces (e.g., electrical and optical connectors) to enable robotic servicing.

In one embodiment hereof, a hybrid electric-laser propulsion (“HELP”) thruster combines features of electric- and laser-type thrusters within a single thruster, as described below. This HELP thruster creates a repeatable exhaust plasma by utilizing a propellant with rapid self-regenerative surface morphology qualities, and by applying a high-powered short-pulse laser to the propellant while applying an electromagnetic or electric field to contain and collimate the trajectory of the exhaust plasma. In certain applications, the HELP thruster may provide a stable, scalable and non-interfering (reduced noise and contamination) propulsion thruster with Iₛₚ's up to about 1,000,000 seconds and an integrated ΔV up to 10,000 m.s⁻¹ (which may be a factor of 1000 greater than the prior art). The HELP thruster's high total impulse resource may for example assist telescopic systems which desire longer on-target dwell times as they can be operated to perform continual de-saturation of its momentum wheels. Since total impulse is specific impulse multiplied by propellant weight, or I=Iₛₚ*m, the total impulse resource is provided by the propellant source.

The HELP thruster may also aid in pointing stability and in providing larger satellites with longer life precision positioning. The higher total impulse resource may also be used to provide small satellites with the capability of changing plane and/or orbit. The higher specific impulse of the HELP thruster may further enable tasks such as station keeping, orbit maintenance and attitude control to also be performed more efficiently than prior art.

The HELP thruster may employ nearly 100% of its propellant, obtaining an efficiency greater than prior art electric- and laser-type thrusters; it may also have reduced weight, cost and power consumption, increased mission lifetime and decreased volume because the propellant is stored in a solid form, as compared to the prior art. Also, the HELP thruster's use of a benign propellant may ease ground handling safety issues (e.g., during test and integration, etc.) and reduce on-orbit contamination issues, as compared with prior art.

The HELP thruster may be modular and scaleable so that the thruster may be tailored to application and mission-system constraints. Multiple, modular HELP thrusters may therefore be combined to create a larger thruster (hereinafter a “multi-HELP thruster”) with a greater thrust operation range. In one embodiment, multiple lasers are combined into the multi-HELP thruster that has higher mass flow and, thereby, thrust.

In another embodiment, lasers of assorted specifications (i.e., lasers with different operation characteristics—power, intensity, wavelength and beam diameter, etc.) may be employed in the multi-HELP thruster so that individual HELP thrusters are separately controllable by system electronics, each with a unique operational and functional capability. A selection of different propellants of varying characteristics (e.g., atomic mass, ionization potential, etc.) may also be employed in the various individual HELP thrusters of the multi-HELP thruster to provide a wide range of on-orbit performance metrics to suit the varying needs of a mission. Accordingly, the multi-HELP thruster may adjust its thrust generation range from ‘low’ (μN) to ‘high’ (mN) thrust levels (through activation of individual HELP thrusters, for example) to add flexibility and cost effectiveness. This may also eliminate the need for a combination of attitude control systems (e.g., thrusters, momentum wheels, etc.) to perform the mission tasks of a satellite. Therefore the use of the multi-HELP thruster may also simplify satellite architecture, reduce satellite bus requirements and reduce the dry weight and complexity as compared to prior art.

In high thrust mode (therefore low Iₛₚ and low ΔV), the HELP thruster may be used to provide small reconnaissance satellites with the capability to perform swift orbit transfers, plane changes, rendezvous or relocation maneuvers. In low thrust mode (therefore high Iₛₚ and high ΔV) the HELP thruster may be used to perform stationkeeping, orbit maintenance, attitude control, and precision pointing and positioning.

In one embodiment, a hybrid electric-laser propulsion (HELP) thruster is provided. A propellant has self-regenerative surface morphology. A laser ablates the propellant to create an ionized exhaust plasma that is non-interfering with a trajectory path of expelled ions. An electromagnetic field generator generates an electromagnetic field that defines a thrust vector for the exhaust plasma. Multiple HELP thrusters may be ganged together, and controlled, according to mission criteria.

In another embodiment, a method provides thrust propulsion to a spacecraft, including: pulsing laser energy onto a propellant having a self-regenerative surface morphology to ablate the surface and form ionized plasma; and generating an electromagnetic field to collimate trajectory of the exhaust plasma to provide thrust.

### BRIEF DESCRIPTION OF THE FIGURES

FIG. 1 shows the ion beam divergence profile of a prior art Indium-Liquid Metal Ion Source 1200 (LMIS 1200) micro-thruster.

FIG. 2 shows an embodiment of a hybrid-electric laser propulsion (HELP) thruster.

FIG. 3 illustrates a passively q-switched microchip laser.

FIG. 4 shows an embodiment of one process for a HELP thruster.

FIG. 5 shows a perspective view of an embodiment of the thruster of FIG. 2.

FIG. 6 shows a perspective view close-up of the thruster of FIG. 5.

FIG. 7 illustrates a perspective view of an embodiment of a propellant feed & gauge subsystem.

FIG. 8 shows an exploded view of the propellant feed & gauge subsystem of FIG. 7.

FIG. 9 illustrates an embodiment of one multi-HELP thruster.

FIG. 10 illustrates an embodiment of one multi-HELP thruster.

FIG. 11 is a graph illustrating various parameter regimes in laser processing.

FIG. 12 shows a flowchart illustrating interaction and feedback associated with laser ablation.

FIG. 13 shows a diagram portraying certain effects resulting from laser exposure.

FIG. 14 illustrates a laser-light intensity regime where plasma shielding arises.

FIG. 15 illustrates the Laser Supported Combustion Wave (LSCW) regime.

FIG. 16 is a flowchart illustrating one embodiment of a propellant initialization process for placing propellant into a ‘ready to ablate’ state for a HELP thruster.

FIG. 17 is a flowchart illustrating one embodiment of a laser initialization process for initializing and operating a laser for a HELP thruster.

FIG. 18 is a flowchart illustrating one embodiment of a collimation field initialization and operation process for a HELP thruster.

FIG. 19 is a flowchart illustrating an embodiment of a method for determining HELP thruster operation as a function of mission criteria.

FIG. 20 is a flowchart illustrating an embodiment of a thruster control strategy process.

FIG. 21 shows an example of a 12×6 thruster transformation matrix M used by the thruster control strategy process of FIG. 20.

FIG. 22 shows an example of a 6×6 Degree of Freedom thrust transformation matrix A used by the thruster control strategy process of FIG. 20.

FIG. 23 shows an example of a 12×6 negative thruster transformation matrix C, in terms of negative thrust components and degrees of freedom, used by the thruster control strategy process of FIG. 20.

FIG. 24 shows an example of a 12×6 positive thruster transformation matrix B, in terms of positive thrust components and degrees of freedom, used by the thruster control strategy process of FIG. 20.

FIG. 25 shows an example of a 12×6 thruster transformation matrix X used by the thruster control strategy process of FIG. 20.

FIG. 26 is a flowchart illustrating an embodiment of a process for controlling a thruster within a multi-HELP thruster.

FIG. 27 is a flowchart illustrating an embodiment of a process for determining HELP thruster configuration and propellant choice per mission criteria.

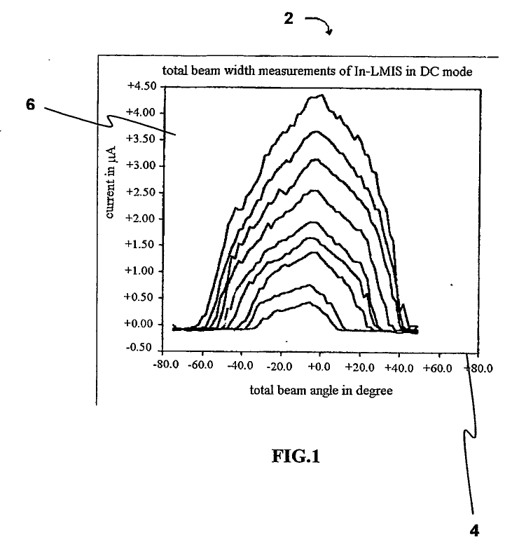

### DETAILED DESCRIPTION

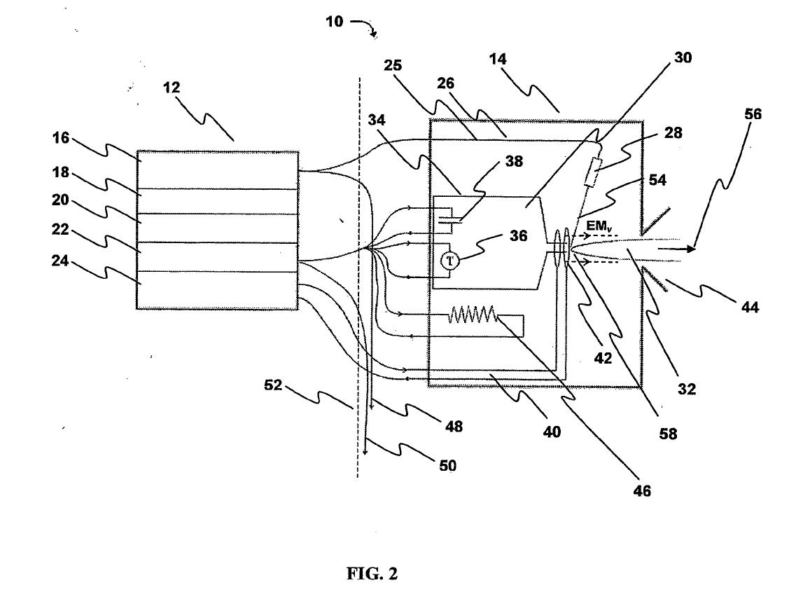

FIG. 2 shows one hybrid-electric laser propulsion (HELP) thruster 10, illustrating certain block functional components of thruster 10 used in thruster operation such as described below. In particular, HELP thruster 10 provides four principle functions: laser ablation, plasma collimation, propellant feed, and control & power conversion; in one embodiment, these functions are implemented by two units: an electronics & control unit 12 and a replaceable modular propellant pod 14.

Unit 12 is shown with a low power, diode pumped solid-state laser array 16, a power converter 18, a micro-controller 20, a propellant control board 22, and an electromagnetic (EM) pulse generator 24. These components of unit 12 enable control of components of unit 14, such as: laser control, closed-loop heater control and control of an electromagnetic field 58.

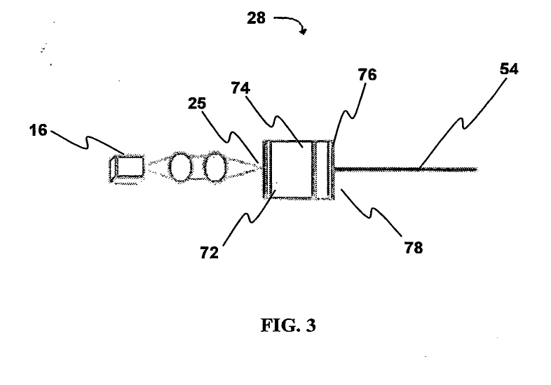

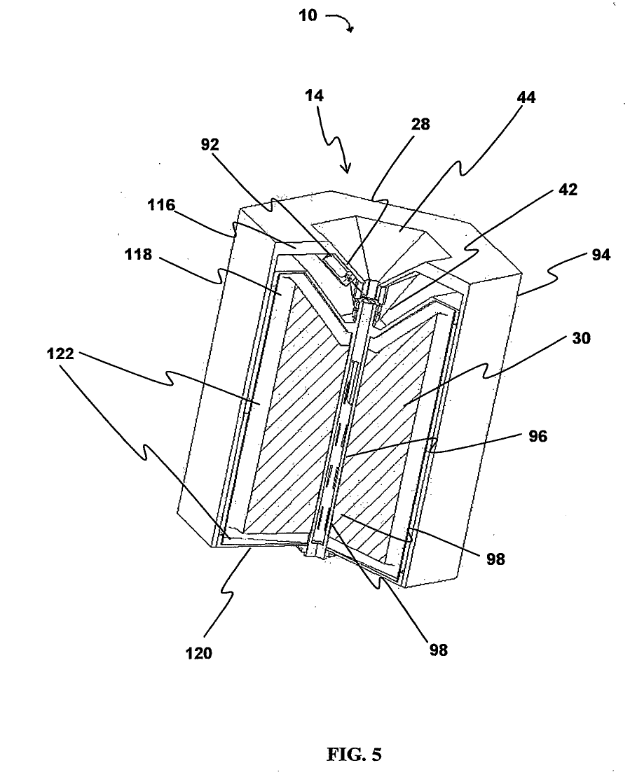

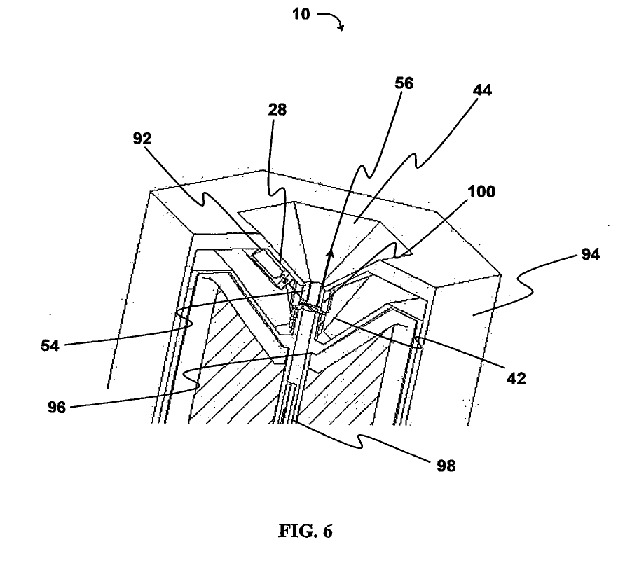

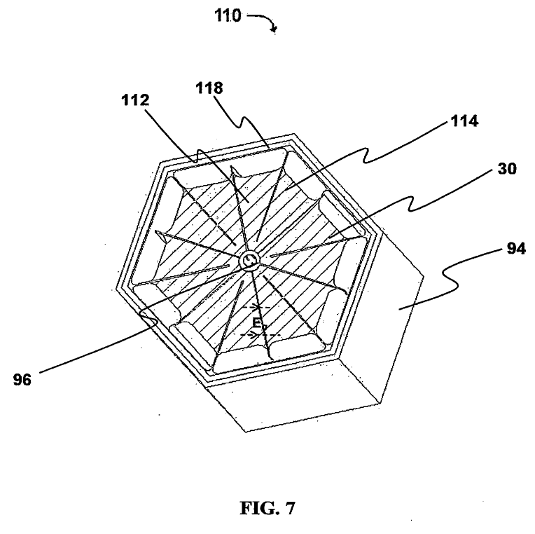

Laser-light 25 from laser array 16 is carried to a Q-switched microchip laser 28 (see FIG. 3) of unit 14 through fiber optics 26; the output laser beam 54 of laser 28 interacts with a propellant 30 to generate an exhaust plasma 32. A propellant module 34 within unit 14 may contain propellant 30 and may additionally include a propellant temperature sensor 36 and a propellant gauge (capacitance bridge) sensor 38 to measure, respectively, propellant temperature and level. An electromagnetic coil 42 has an electromagnetic pulse current 40 applied to it so that electromagnetic field 58 is generated which will contain exhaust plasma 32 until it leaves a nozzle 44 of unit 14. A propellant heater 46 assures that propellant 30 has appropriate temperature for a propellant feed & gauge subsystem 110 (see FIG. 7), to provide rapid self-regenerative surface morphology.

Electronics & control unit 12 may include fiber optic pigtails 48 and an electrical bus 50 to provision, respectively, optical and low voltage signals to other propellant pods 14 (e.g., within a multi-HELP thruster 130 as shown in FIG. 9). In particular, if multiple HELP thrusters 10 are used by a single satellite, one electronics & control unit 12 may be used to provide the necessary optical and low voltage signals to the other propellant pods 14 (as in FIG. 9). This may save valuable volume and mass making it an appealing option for small satellites that typically are both mass and volume limited. The electronics & control unit 12 is also shown with a robotic detachment interface 52, to enable ‘plug-and-play’ to satellite for command and telemetry interfacing, for example.

In one embodiment, laser-light 25 has a wavelength of 808 nm. Q-switched microchip laser 28 has an input mirror 72, a monolithic block of either Nd:YAG or Nd:YVO4 material 74 coupled with a Cr⁴⁺:YAG saturable absorber 76 and an output mirror 78 (see FIG. 3). The Nd atoms are excited by the 808 nm pumped laser-light 25 to lase at 1.06 μm. The output from Q-switched microchip laser 28 is an intense high repetition rate pulsed laser beam 54 that is directly focused onto the regenerative target surface 100 of propellant 30 (see FIG. 6). The action of focusing laser beam 54 onto target surface 100 of propellant 30 results in the production of highly ionized exhaust plasma 32, which provides thrust 56. Electromagnetic coils 42 generate electromagnetic field 58 (also denoted herein as plasma collimation field EM_{ν}), which is used to “contain” the initial exhaust plasma 32 produced by laser beam 54 and to control and improve the collimation of the trajectory of the ions of exhaust plasma 32 expelled from the target propellant 30. This focuses the trajectory of exhaust plasma 32 to provide improved system performance of specific impulse and thrust.

The use of electromagnetic coils 42 to generate electromagnetic field 58 to control and focus the velocity distribution of exhaust plasma 32 may reduce contamination and cross-coupling effects. Nonetheless, a contamination baffle housing 92 (see FIG. 5) may surround laser 28 so as to protect it from stray exhaust plasma 32 ions or particulates that may release upon ablation of target propellant 30, as a preventative measure to minimize performance deterioration of laser 28.

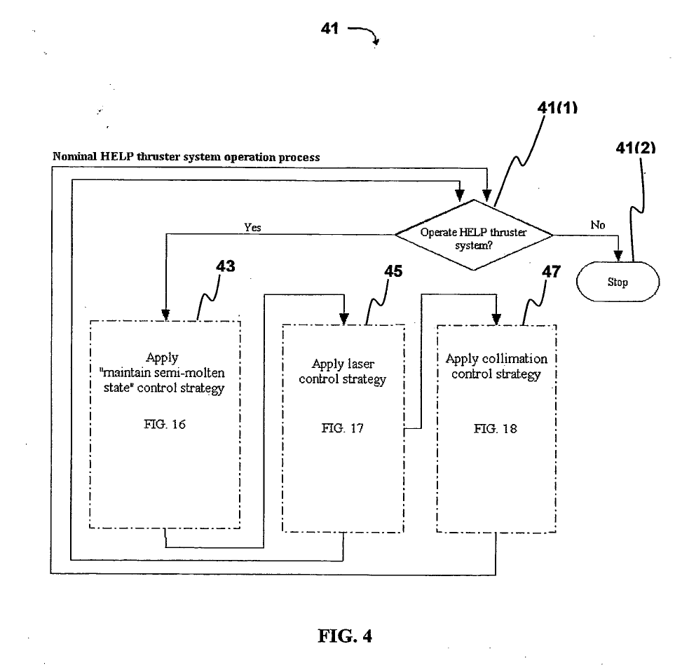

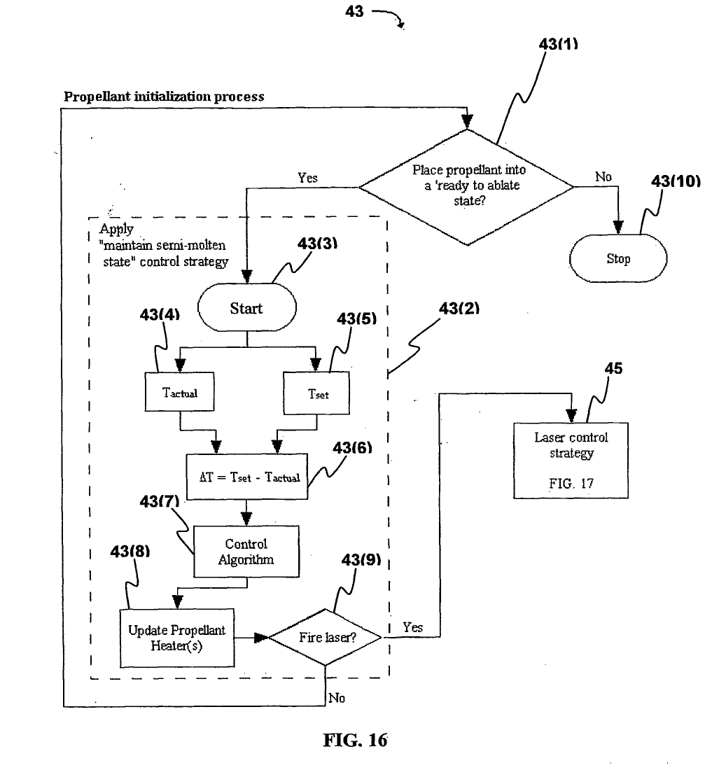

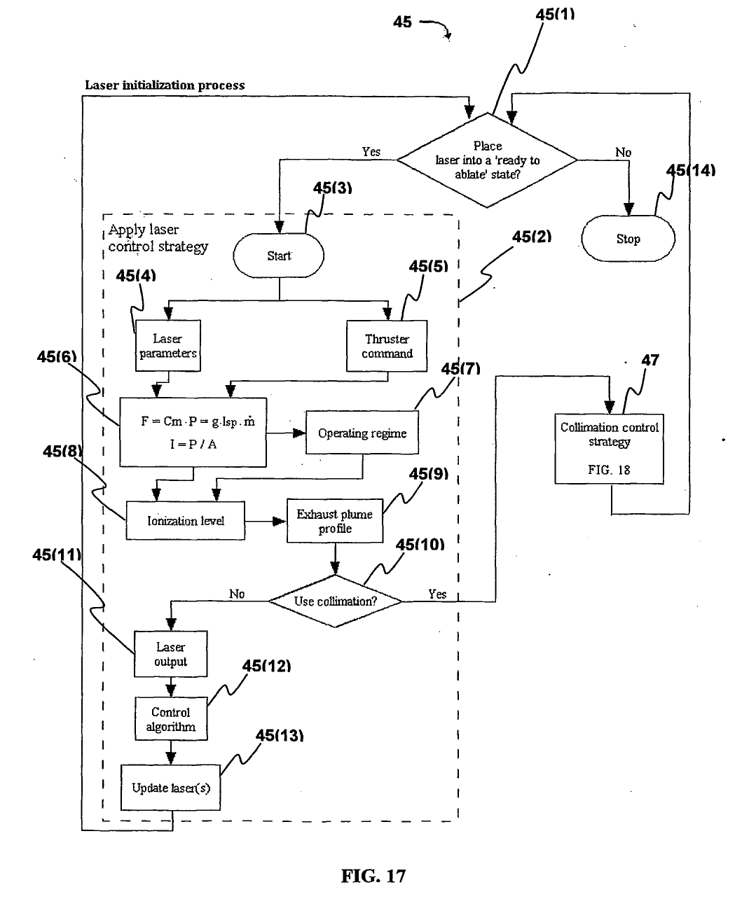

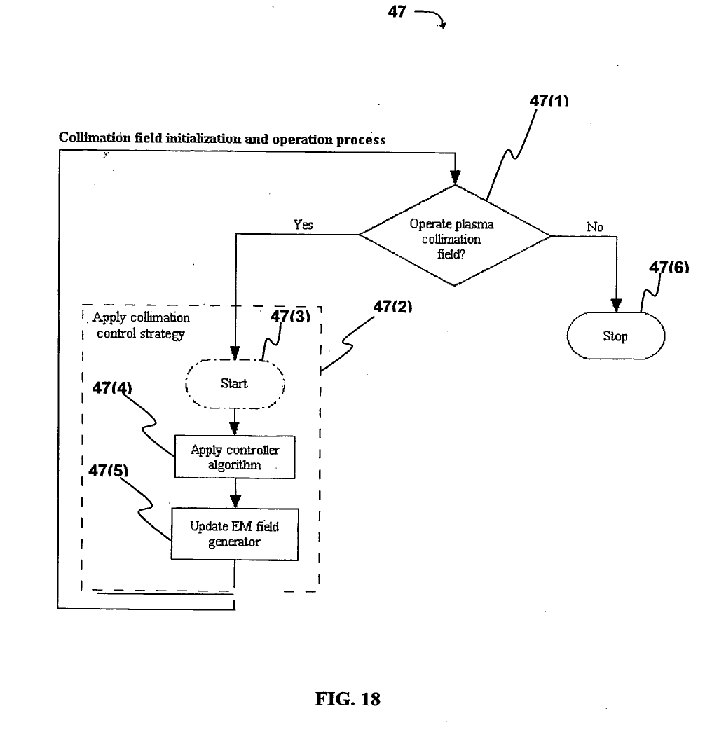

Operation of HELP thruster 10, FIG. 2, may be implemented in accordance with process 41, FIG. 4, which illustrates certain functional capabilities of HELP thruster 10 such as a propellant feed process 43, a laser ablation process 45, and a plasma collimation process 47. As shown, a first step of process 41 involves determining 41(1) whether to operate HELP thruster 10 or not. If 41(1) yes, process 41 advances to processes 43, 45 and 47; if 41(1) no, process 41 ends 41(2). Process 43 entails maintaining propellant 30 in a semi-molten state, while the latter two processes 45, 47 involve, respectively, operating and controlling (a) laser(s) 16 & 28 and (b) collimating electromagnetic field 58. FIG. 16, FIG. 17 and FIG. 18 show further exemplary detail of processes 43, 45 and 47, respectively. Process 43 may for example be commanded and controlled by propellant control board 22 of unit 12 and be implemented by propellant feed & gauge subsystem 110 of unit 14. Process 45 may for example be implemented by diode pump laser array 16 and micro-controller 18 of unit 12 and Q-switched microchip laser 28 of unit 14. Process 47 may for example be commanded and controlled by electromagnetic pulse generator 24 of unit 12 and be implemented by electromagnetic coil 42 of unit 14.

In particular, FIG. 16 is a flowchart illustrating one embodiment of process 43, to place propellant 30 into a ‘ready to ablate’ state for use with HELP thruster 10. As shown, a first step of process 43 involves determining 43(1) whether “propellant feed” process should be activated or not. If 43(1) yes, a sub-process 43(2) is initiated 43(3) to use the outputs of propellant temperature sensor 36 T_{actual} (43(4)) and the commanded propellant temperature Tₛₑₜ (43(5)) to calculate 43(6) the set point difference ΔT (ΔT=Tₛₑₜ−T_{actual}). Sub-process 43(2) then implements 43(7) a control algorithm—for example a proportional integral derivative (PID) control algorithm to control and update 43(8) the propellant heater(s) 46 (e.g., to correct temperature set point differences). A final step of sub-process 43(2) involves determining 43(9) whether to advance to process 45. If 43(9) “laser ablation” process 45 is to be activated (yes), process 43 advances to process 45. If 43(1) “propellant feed” process 43 is not to be activated (no), process 43 ends 43(10).

FIG. 17 is a flowchart illustrating one embodiment of process 45 to initialize and operate laser(s) 16 & 28 and ablate target propellant 30 of HELP thruster 10. As shown, a first step of process 45 involves determining 45(1) whether “laser ablation” process should be activated or not. If 45(1) yes, a sub-process 45(2) is initiated 45(3) to use operation parameters (45(4), e.g., pulse width τ, beam diameter d, frequency ν, etc.), of lasers 16 & 28, and commanded thrust F or specific impulse Iₛₚ (45(5)) to calculate 45(6) the required laser power P and intensity I (F=Cₘ·P=g·Iₛₚ·\dot{m}). Sub-process 45(2) then determines 45(7) the corresponding dynamic behavior laser ablation operating regime and determines 45(8) the expected constituents and ionization level of exhaust plasma 32. The next step of sub-process 45(2) involves calculating 45(9) the expected profile and divergence angle of exhaust plasma 32. Using this information, the next step of sub-process 45(2) entails deciding 45(10) whether to advance to process 47. If 45(10) no, sub-process 45(2) re-calculates 45(11) the required laser power and intensity to compensate for the divergence angle. This sub-process 45(2) then implements 45(12) a control algorithm—for example a proportional integral derivative (PID) control algorithm to control and update 45(13) laser(s) 16 & 28, for example to generate commanded thrust. If 45(10) “plasma collimation” process 47 is to be activated (yes), process 45 advances to process 47. If 45(1) “laser ablation” process 45 is not to be activated (no), process 45 ends 45(14).

FIG. 18 is a flowchart illustrating one embodiment of a process 47 to initialize and operate collimating electromagnetic field 58 for use with HELP thruster 10. As shown, a first step of process 47 involves determining 47(1) whether “plasma collimation” process should be activated or not. If 47(1) yes, a sub-process 47(2) is initiated 47(3). Sub-process 47(2) entails applying 47(4) a control algorithm—for example a proportional integral derivative (PID) control algorithm—to control and update 47(5) electromagnetic field 58 to collimate exhaust plasma 32 and generate thrust. If 47(1) “plasma collimation” process 47 is not to be activated (no), process 47 ends 47(6).

FIG. 5 shows an embodiment of one HELP thruster 10. A hexagonal tubular lightweight assembly 94 provides the core structure that other thruster components are attached to or are contained within. The construction of the lightweight assembly 94 also forms nozzle 44 and provides thermal shielding and control. The perspective, cut-away view of FIG. 5 also reveals underlying layers of this embodiment of HELP thruster 10, and helps to illustrate operation of propellant feed & gauge subsystem 110 (FIG. 7). In particular, propellant feed & gauge subsystem 110 is shown with a propellant capillary feed tube 96 and propellant capillary inlet feed slots 98, which provide HELP thruster 10 with a mechanism to feed propellant 30 to target surface 100 in a 1 g or zero g environment. FIG. 6 shows a close-up of HELP thruster 10, displaying an enhanced view of ablation of target surface 100 of propellant 30.

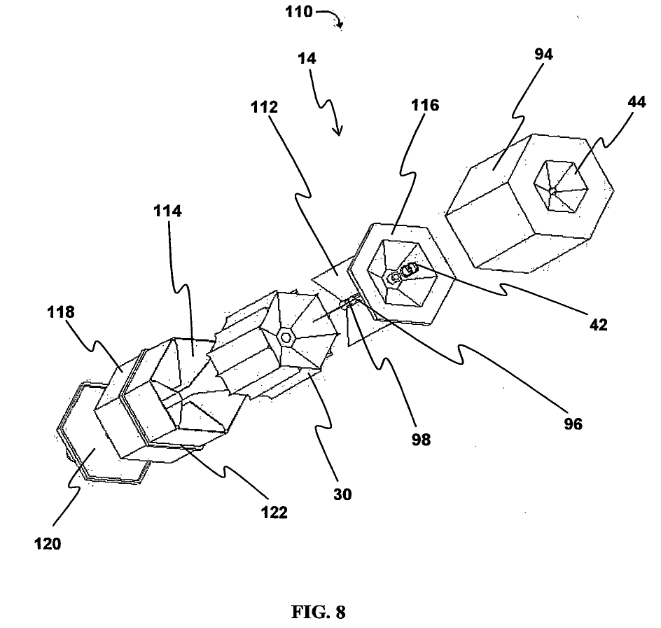

FIG. 7 shows an embodiment of one propellant feed & gauge subsystem 110, suitable for use within HELP thruster 10; an exploded view of subsystem 110 is shown in FIG. 8. Propellant feed & gauge subsystem 110 may enable efficient delivery of propellant 30 to point of ablation (i.e., ablation of target surface 100) via a capillary subsystem 96 & 98. Propellant feed & gauge subsystem 110 provides for gradual replenishment of propellant 30 at ablation of target surface 100 (for example a 1 mm² area near electromagnetic coils 42). Propellant gauge (capacitance bridge) sensor 38 (FIG. 2) determines the amount of remaining propellant 30 by reading the saturation of the capillary ducts (formed by ‘inner’ 112 and ‘outer fins 114 of propellant pod 14).

In one embodiment, propellant pod 14 includes a propellant storage container, including a propellant container top 116, a propellant container conductive outer shell 118 and a propellant container bottom 120. Gauging of propellant level may be determined by the dielectric constant of propellant 30. For propellant feed & gauge subsystem 110, propellant 30 with an appropriate dielectric constant (i.e., a constant sufficient to support a self-sustaining electric field E_{g}) is desired to ease the task of gauging propellant level. Hexagonal propellant storage container 116, 118 & 120 (see FIG. 8) may be formed of two sections: 1) propellant conductive outer shell 118 that has internal ‘outer’ fins 114, and that has an attachable propellant container bottom 120 (see FIG. 8); and 2) an inner conductive capillary feed tube 96 with capillary inlet feed slots 98 (see FIGS. 5 & 8) and extending ‘inner’ fins 112 connected to a container top 116. Container top 116 is electrically isolated from conductive outer shell 118 by a thermal isolator 122. The inner sections 96, 98, 112 & 116 are configured to enable heating of propellant 30 and allow inflow of propellant 30 into the center of capillary feed tube 96.

Propellant pod module 34 (see FIG. 2) operates such that a voltage applied to ‘outer’ fins 114 on conductive outer shell 118 establishes electric field E_{g} in the enclosed propellant region 30 and between ‘outer’ fins 114 and ‘inner’ fins 112 of inner section 116. This allows an associated capacitance to be determined (via propellant gauge (capacitance bridge) sensor 38 (see FIG. 2)), to gauge the amount of available propellant 30. Propellant feed & gauge subsystem 110 is for example constructed and arranged to work in 1 g or zero g based on the surface tension of propellant 30. The entire propellant pod module 34 (see FIG. 2) may be encapsulated in a thermally isolated lightweight assembly 94 so that temperature control of propellant 30 is achievable whether propellant pod 14 views direct sunlight or deep space.

FIG. 9 shows one embodiment of a multi-HELP thruster 130. In FIG. 9, modular HELP thruster 10 (FIG. 5) is implemented multiple times within a larger system multi-HELP thruster 130, sized to accommodate the application. One exemplary use of multi-HELP thruster 130 is to provide propulsion for plane or orbit changes and precision maneuvers for a wide selection of satellite ranging from large satellites to nano-satellites.

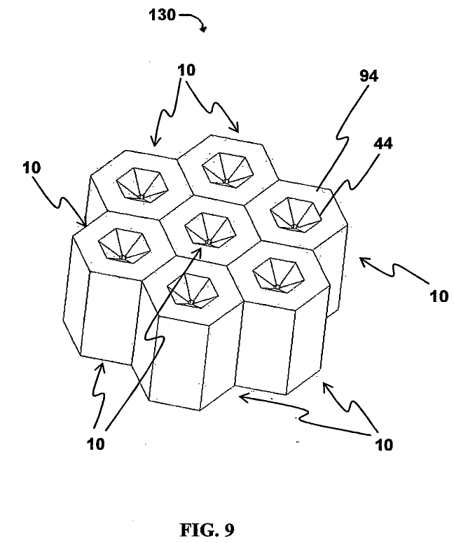

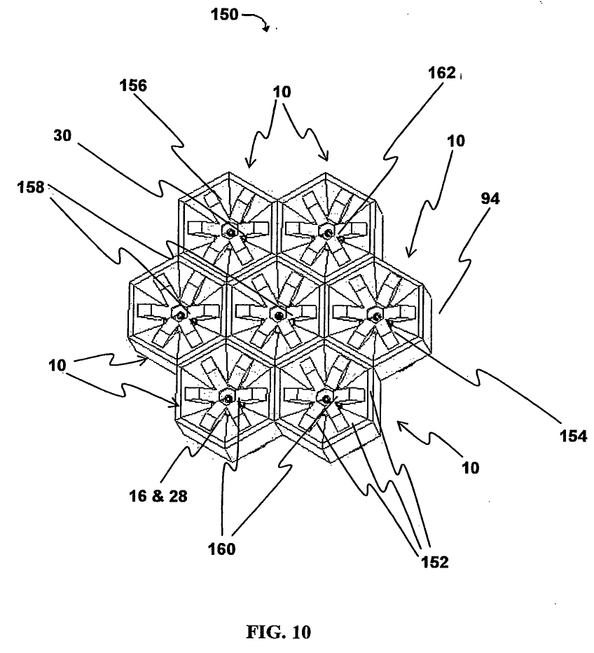

FIG. 10 shows a perspective view of one embodiment of multi-HELP thruster 150. In FIG. 10, modular HELP thruster 10 (FIG. 5) is again used multiple times within larger system multi-HELP thruster 150, sized to accommodate the application. In FIG. 10, multi-HELP thruster 150 is shown with various types of lasers (16 & 28, 152, 154, and 156)—of assorted operation specification to provide differing capability and desired performance (e.g., desired thrust or Iₛₚ),—and with various types of propellants (30, 158, 160 and 162)—of assorted characteristics to provide differing capability and desired performance. The individual HELP thrusters 10 of Multi-HELP thruster 150 may be separately controlled by electronics, each with a unique operational and functional capability, to provide an adjustable and wide range of on-orbit performance metrics to suit varying mission needs, such as orbit raising, precision attitude control, precision pointing, etc.

Desired characteristics of propellant 30 may include: 1) low ionization potential (e.g., having a value to enable generation of ions with high charge states that impart desired specific impulse); 2) a high surface tension (e.g., having a value to enable surface replenishment to ensure repeatability); 3) low vapor pressure (e.g., having a value that reduces outgassing); 4) proper melting points (e.g., having a value that limits required power for propellant 30 temperature and phase state control); 5) composition of benign constituents to reduce contamination and increase system applicability. Other properties of interest for propellant 30 may include appropriate density, viscosity, surface wetting, and dielectric constant to enable proper functioning of propellant feed & gauge subsystem 110 (see FIGS. 7 & 8). An example of propellant 30 that has at least certain of the above described qualities and characteristics is Paraffin; though other materials may be used. Paraffin an ‘engineered chemical’ such that it may be customized to provide the desired characteristics and qualities. Other propellants may be doped with materials (e.g., metals) or engineered in another way to provide the aforementioned desired characteristics and qualities.

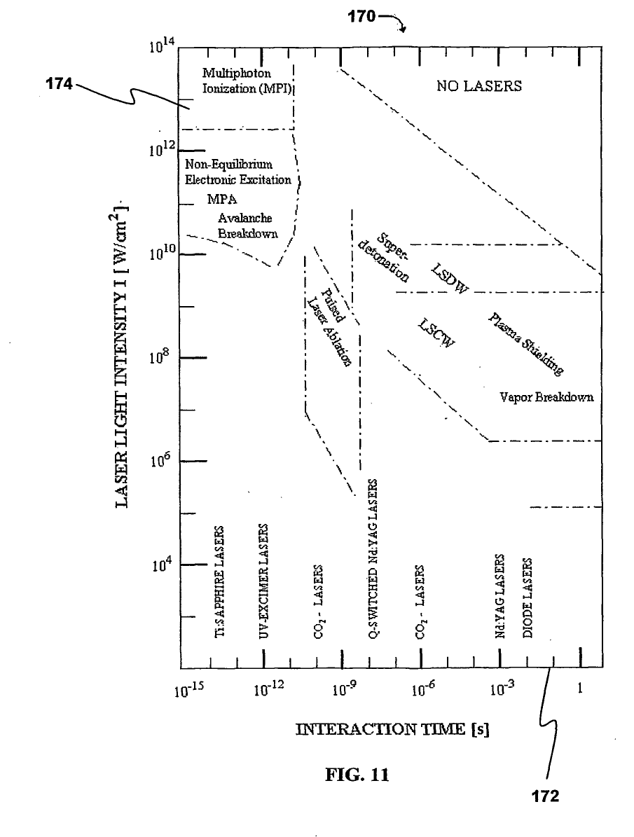

Propellant 30 may be contained within propellant storage container 116, 118 & 120 to reduce exposure to the space environment (vacuum) to reduce loss of propellant 30 via vaporization (which may reduce efficiency of propellant 30). The process of laser ablation, which removes material via laser-light, is complex and involves different processes depending on how laser-light interacts with the target material. A graph 170 of FIG. 11 provides an overview of various parameter regimes in laser processing. In FIG. 11, x-axis 172 relates to interaction time of laser-light and corresponding laser-light intensity (y-axis 174). The principal processes that are responsible for the onset of ablation are ‘photochemical’, ‘photothermal’ and ‘photophysical’.

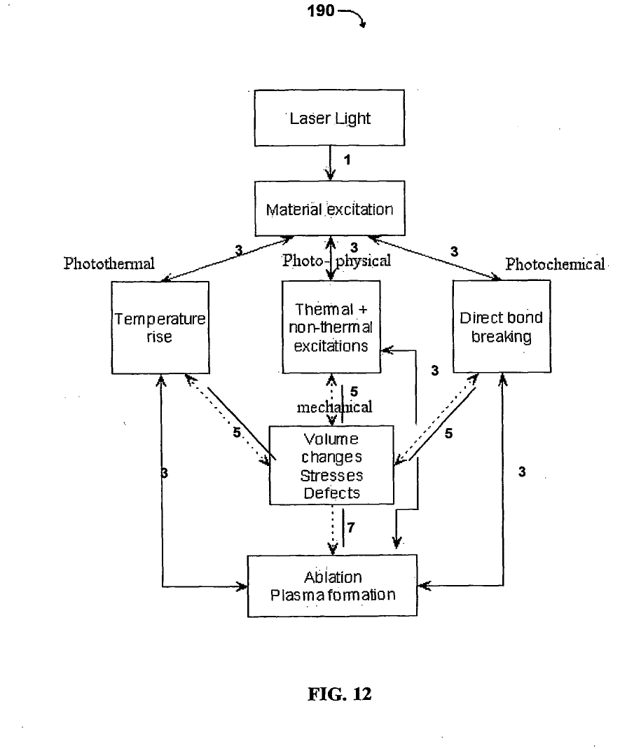

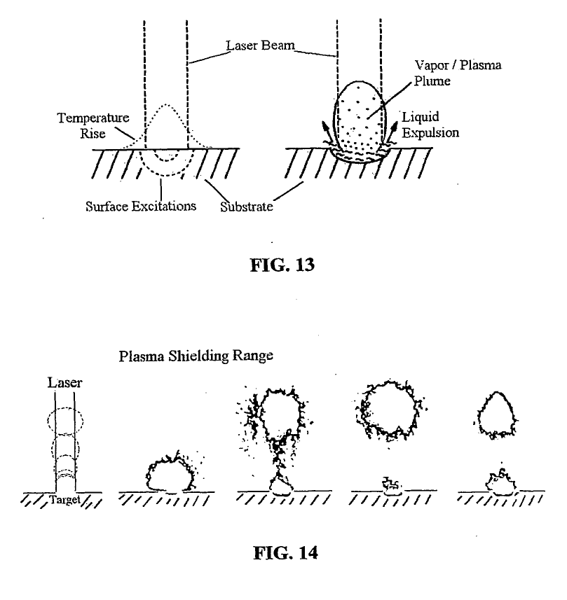

FIG. 12 is a flowchart 190 illustrating interaction and feedback mechanisms involved in laser ablation. Paths numbered 1 indicate direct paths resulting in ablation; paths numbered 3 indicate direct paths resulting in ablation, but which have coupling between processes; paths numbered 5 indicate indirect paths resulting in ablation, but which have coupling between processes; and paths numbered 7 indicate indirect paths resulting in ablation only. Ablation via photochemical process, for example, involves breakdown of chemical bonds in a molecule; while photoablation involves heating of material and photophysical refers to a combination of both photochemical and photothermal processes. In a process termed ‘mechanical,’ referring to laser-light induced volume changes, stresses and defects arising in material can also result in ablation. The interaction between laser beam 54 and target propellant 30 is thus dependent on both the parameters of laser beam 54 (e.g., pulse width, fluence, wavelength of laser-light, intensity, and width of laser focus, etc.) and the physical and chemical properties of target propellant 30 (e.g., bulk elemental composition, melting- and boiling-points, reflectivity, and particle size, etc.). Typically the excitation energy from laser beam 54 is dissipated into heat; thus the photothermal process may be the dominant cause of ablation. The dominant effects that result from laser exposure include laser-induced ‘melting’, ‘vaporization’ and ‘plasma formation’, and are defined by laser-light intensity (see FIG. 13 and FIG. 11).

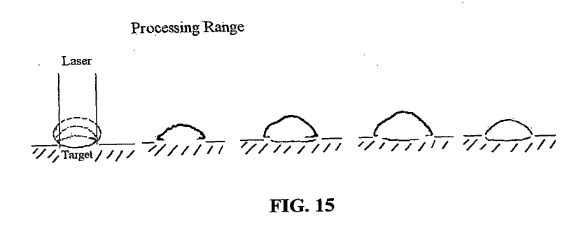

With regard to the application of laser ablation in HELP thruster 10, as propellant 30 is removed to form exhaust plasma 32, energy is released at velocities producing specific impulses Iₛₚ. There are three different dynamic behavior regimes associated with plasma formation: ‘laser-supported combustion waves (LSCW)’, ‘laser-supported detonation waves (LSDW)’ and ‘superdetonation’, each of which is dependent upon laser-light intensity. The wavelength of laser-light can also impact how laser interacts with propellant. For example, if laser-light intensity reaches a critical value, typically 10⁷ W/cm²<I_{cr}<10¹⁰ W/cm², then, depending on laser-light wavelength, plasma shielding (FIG. 14) can arise; that is, in this condition laser beam 54 does not reach the target substrate but instead is completely absorbed by exhaust plasma 32, resulting in weak coupling between exhaust plasma 32 and the target substrate, inhibiting energy transfer (i.e., laser-induced material vaporization stops). The first regime is that where LSCWs occur, specifically where laser-light intensity I is high enough to cause optical breakdown within the gas/vapor in front of target substrate, but where it is too low to cause a detonation wave (Iₚ≦I≦I_{d}). Under this circumstance, exhaust plasma 32 remains stationary and is confined to a region near the surface of propellant 30 (see FIG. 15); unless the intensity increases, in which case exhaust plasma 32 expands away from target propellant 30. The second regime involves higher laser-light intensities, specifically I≧I_{d}, where I_{d}>10⁸ W/cm²; here, ablated propellant propagating away with supersonic speeds generates a shock wave that drives both the ambient medium and the target substrate. In this case, the velocity of shock wave in the ambient medium is approximately equal to that of the ionization front. The propagation velocity of a LSDW ν_{dw} can be approximated by

$${v}_{dw} \approx {( 2 ( {γ}^{2} - 1 ) \frac{I}{{ρ}_{g}} )}^{1 / 3} ∝ {I}^{1 / 3} ,$$

where γ is the adiabatic coefficient ≈5/3, and ρ_{g} is the density of the ambient medium. The third regime involves high laser-light intensities, typically I≧10⁹ W/cm², where superdetonation arises. Under this condition, the ionization front propagates in front of a shock wave. The propagation velocity of superdetonated ionization waves ν_{sd} can be described by
ν_{sd}∝Iⁿ,
where n>1, and where values for ν_{sd} may reach values on the order of 10⁹ cm/s and Iₛₚ's up to 1,000,000 seconds are achievable.

However, with lasers that provide joules to kilojoules of energy within ultra-short pulse-widths τ (τ≦hundred picoseconds), laser interaction processes and effects preside. Continuous-wave (microsecond and longer pulse-width lengths) irradiation leads to momentum transfer via compression waves in laser-sustained exhaust plasma 32, as discussed above, while high-energy short pulse-width (τ≦10⁻¹⁰ s) irradiation leads to momentum transfer through direct ablation of material. This later process is the more energy efficient process—more efficient by which momentum transfer is instigated—and therefore it may provide better specific impulses and mass-power ratios than continuous wave irradiation. The use of short-pulse high-energy lasers 16 & 28 may thus be used with HELP thruster 10 to increase specific impulse and mission ΔV capability, since exhaust plasma 32 velocity is proportional (though not linearly) to laser-light intensity. The specific impulse Iₛₚ imparted by such short-pulse ablation dominated momentum transfer induced processes is given by

$${I}_{sp} ≡ \frac{1}{W} {\int }_{{t}_{0}}^{{t}_{f}} F ( t ) ⅆ t = \frac{1}{W} {\int }_{{t}_{0}}^{{t}_{f}} \frac{ⅆ P ( t )}{ⅆ t} ⅆ t = \frac{P}{W} = \frac{{m}_{ex} {v}_{ex}}{{m}_{ex} {g}_{o}} = \frac{{v}_{ex}}{{g}_{o}} ,$$

where W is the weight of ablated propellant and F(t) is thrust as a function of time t. The integral presents an impulse applied to the target substrate (i.e., propellant 30) and the time interval (t₀, t_{f}) over which the integration takes place is defined by the duration of ablation (duration of mass-removal from target substrate). This interval is typically incomparably longer than the pulse-width of irradiating laser 16 & 28 and is about equal to lifetime of exhaust plasma 32. νₑₓ is the mean propellant velocity, mₑₓ is the mass of ablated propellant, gₒ is the acceleration due to gravity and P is the acquired momentum per pulse. Therefore, assuming the ablated propellant has the same mean velocity in accordance with the above equation, Iₛₚ is deduced from the speed of ions of ablated exhaust plasma 32. For a graphite target, exhaust velocities of ˜2⁵ m/s (using a Nd:YAG laser with irradiance of 3×10¹³ W/cm², and τ of 100 ps at λ of 532 nm) are achievable, corresponding to specific impulses of ˜20,000 s. A strong dependence between gained velocity (∴Iₛₚ) and target material is also apparent—exhaust velocity (∴Iₛₚ) decreasing with increasing atomic mass. Accordingly, propellant 30 may be selected with the appropriate characteristics to achieve desired performance.

The length of a laser pulse τ to make ablation the dominant mechanism of momentum transfer relates to the critical electron density of exhaust plasma 32, or N_{ce}. Specifically, the upper limit of τ is set by the time that it takes to develop a high-density exhaust plasma 32 that is opaque to further transmission of the laser beam's 54 energy. This phenomena (total reflection of laser-light) occurs when the complex refractive index of exhaust plasma 32 is purely imaginary and its frequency exceeds a critical value ν_{ct}=ν, the frequency of incident laser-light. Under such circumstances the corresponding critical electron density N_{ce} is given by

$${N}_{ce} = \frac{{m}_{e} {ɛ}_{0} {v}_{cr}^{2}}{{ⅇ}^{2}} ,$$

where mₑ is electron mass, ε₀ is permittivity of free space, ν_{cr} is critical plasma frequency, and e is electron charge. Accordingly, and as noted above, HELP thruster 10 may employ short pulse-width Q-switched microchip laser 28 with a wavelength of 1.06 μm in laser beam 54, providing critical electron density of, for example, N_{ce}˜2.5×10²⁵ m⁻³. Assuming impact ionization is the predominant mechanism of electron density growth, and disregarding multiphoton ionization and loss mechanisms (since the timescales are so small), then the following equation results

$$\frac{ⅆ {N}_{ce}}{ⅆ t} = {r}_{l} \cdot {N}_{ce} , ⇒ {t}_{cr} = ln ( {N}_{ce} ) / {r}_{i} ,$$

where t_{cr} is the approximate upper limit on the critical time (i.e., the required length of a laser pulse τ to make ablation dominant mechanism of momentum transfer) and rᵢ is the ionization rate. Taking rᵢ˜6e¹¹ s⁻¹, an upper limit of τ is −100 ps. Short pulse-widths are also desirable as they reduce the heat-affected zone, which in turn reduces collateral damage to target surface 100 and the work involved in replenishing the surface. The high intensity also increases the specific impulse and mission ΔV capability of HELP thruster's 10 since exhaust plasma 32 velocity is proportional to laser-light intensity.

The process of laser ablation raises thrust repeatability issues, due to a change in the target's surface morphology with repeated exposure to pulsed laser energy. Dramatic surface morphology changes occur as the laser “bores into” the target surface; this influences the characteristics of exhaust plasma and thus the thrust or produced Iₛₚ. Consequently, avoiding re-exposure of the propellant's target surface ensures repeatability in a thruster utilizing laser ablation. HELP thruster 10, FIG. 2, solves this repeatability issue by continually forming a virgin surface before repeated exposure by laser beam 54, by utilizing the natural surface tension of propellant 30. In one embodiment, therefore, propellant 30 exhibits rapid self-regenerative surface morphology; it is stored in solid form, and is then heated so that its surface converts to a semi-molten state so that its surface tension naturally and continually reforms with a new smooth target surface 100 layer. Thus, target surface 100 of propellant 30 may be re-exposed to laser beam 54 to produce a repeatable thrust level 56 with reduced waste of propellant 30, enabling nearly 100% usage of propellant 30 with reduced dead weight (and with no moving parts).

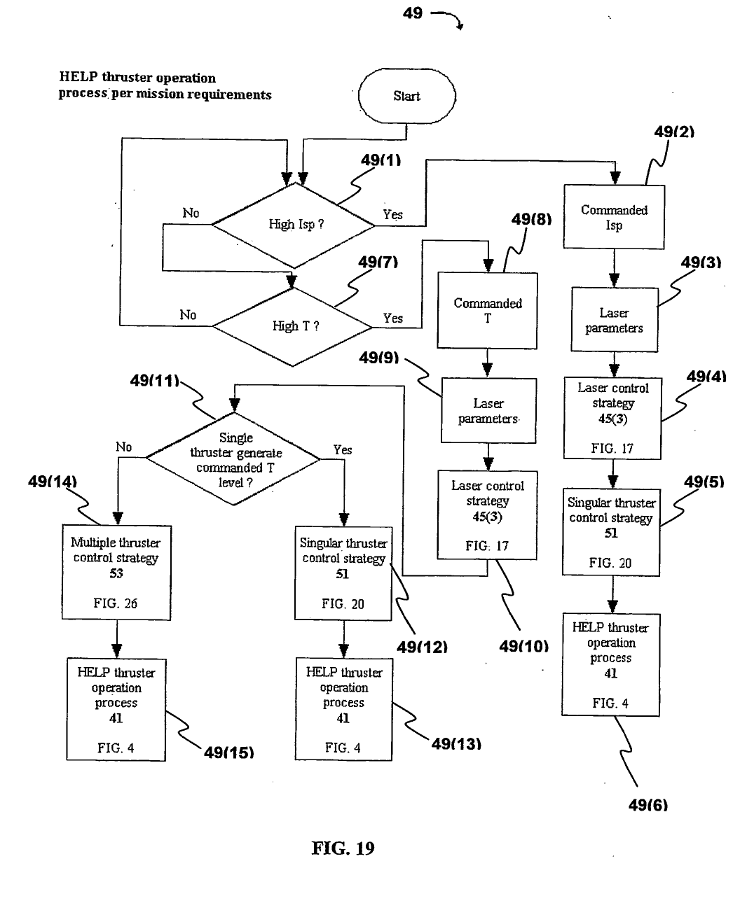

To maintain propellant 30 in a molten state with adequate surface tension while laser illuminated and exposed to the space environment, control algorithms may be employed (such as shown and described in connection with FIG. 16, FIG. 17, FIG. 18, FIG. 20). These algorithms may employ sensors such as propellant temperature sensors 36 and precision propellant heaters 46 (FIG. 2). For example, FIG. 16 shows process 43 that places propellant 30 into a ‘ready to ablate’ state and maintains propellant 30 in a semi-molten state during operation of HELP thruster 10.

Q-switched microchip lasers 28 may provide excellent beam quality and increased peak pulse power over traditional gas lasers, facilitating operation of HELP thruster 10 since more energy per pulse is transferred to exhaust plasma 32, resulting in increased exhaust plasma 32 velocity and, thereby, increased specific impulse and mission ΔV capability.

Passive Q-switching involves use of saturable absorber 76 within the laser cavity to delay the onset of lasing. Specifically, the laser pump energy is accumulated within the saturable absorber 76 material until it reaches the saturable absorber 76 material's saturation point (most of the atoms/molecules are in a high-energy state), at which point saturable absorber 76 material becomes bleached and transparent to the incident laser-light 25 and then emits a short high-energy laser beam 54 pulse. This train of short, extremely repeatable pulses may enable a very low and very precise minimum impulse bit (MOB). FIG. 3 shows an exemplary configuration of passively Q-switched microchip laser 28.

HELP thruster 10 may be operated in a pulsed or pseudo-steady-state continuous mode. The pseudo-steady-state continuous mode is achieved, for example, by operating passively Q-switched microchip laser 28 at high repetition rate (10-100 kHz) compared to satellite system's response resonances. Those skilled in the art appreciate that other lasers with like specifications may also be employed in HELP thruster 10 without departing from the scope hereof.

In one embodiment, HELP thruster 10 employs passively Q-switched Nd:YAG microchip laser 28 to produce very short pulse-widths (<218 ps) and very high peak powers (≧565 kW), which is up to 50 times greater than produced by conventional Q-switched lasers. Such a laser 28 is therefore inherently robust and reliable; it may also be packaged into very small volumes (≦7e⁻⁵ cm³ laser system is currently available from Uniphase), making it an economical choice over other lasers. Other features of such lasers include reported electrical efficiency (≧35%) and high mean-time-between-failure (MTBF) of 1 million hours (˜114 years).

As noted above, HELP thruster 10 utilizes electromagnetic field 58 to contain the initial exhaust plasma 32 until it leaves the nozzle 44, providing an efficient and directed (collimated) momentum transfer of propellant 30. In operation, electromagnetic field 58 focuses and narrows the velocity distribution function of exhaust plasma 32; this may increase achievable specific impulse and thrust 56 while improving system performance and reducing contamination and cross-coupling effects. Electromagnetic field 58 may be induced, for example, with a tiny modified Helmholtz coil (e.g., electromagnetic coil 42) positioned at the aperture of ablation nozzle 44 and during pulse firing of Q-switched microchip laser 28. Two principles of exhaust plasma 32 may illustrate the principle of this containment. First, in the creation of exhaust plasma 32 in the “superdetonation” regime, target surface 100 is heated so intensely and so quickly that individual atoms reach ionization temperature and quickly shed their electrons. Electrons, because they are lighter than ions, “rush” away from target surface 100 causing an electric field E to be created, which, in turn acts upon them and accelerates them away from target surface 100. The complex and rapid interaction forming exhaust plasma 32 is assisted by short pulses of electromagnetic field EM_{ν} 58 that momentarily confine electrons to a focused column. The density and temperature of exhaust plasma 32 is such that exhaust plasma 30 is “magnetized” and therefore “freezes in” the local magnetic field present at its creation. The combination of these effects combine to force exhaust plasma 32 to move rapidly away from target surface 100, creating a high momentum coupling for the mass and velocity and a reduction in the commensurate contamination. In this operation, the electronics & control unit 12 that controls laser(s) 16 & 28 also administers the pulse to generate electromagnetic field 58.

Certain issues associated with multi-HELP thruster design and construction may include: 1) how many individual thrusters 10 should be used; 2) how should individual thrusters be physically distributed and configured in terms of position and orientation on satellite; 3) how should individual thrusters be controlled and operated; and 4) how should thruster configurations be evaluated. These issues impact the degree of control (“control authority”) available to satellite as well as the thruster's lifetime and efficiency, and therefore the suitability of thruster to specified mission.

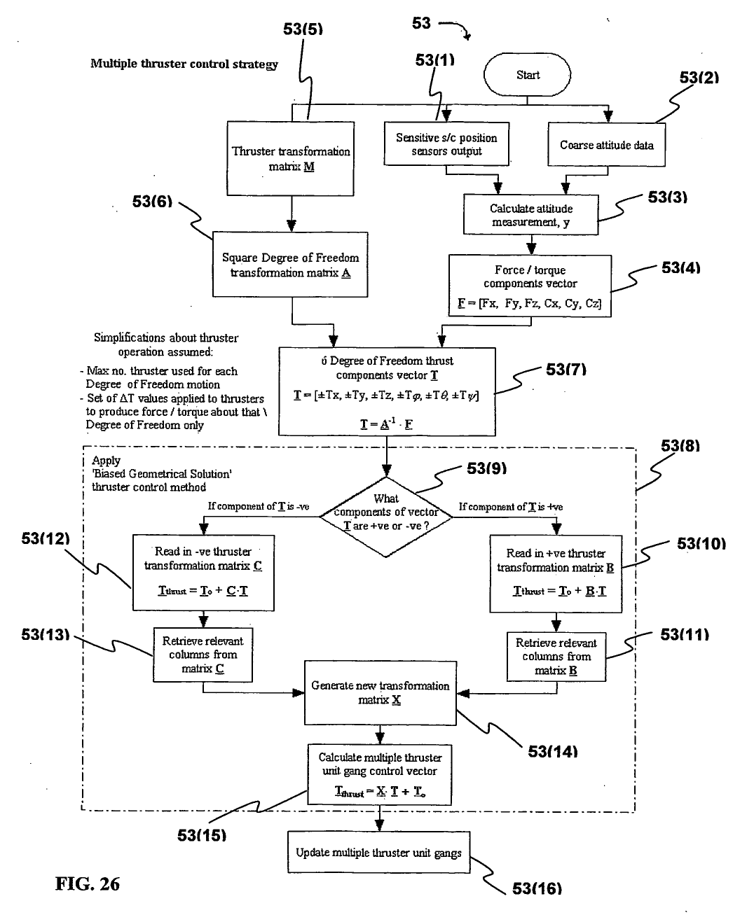

Accordingly, FIG. 19 is a flowchart illustrating an embodiment of a method for determining HELP thruster operation as a function of mission criteria. As shown, a first step of process 49 involves determining 49(1) whether a high specific impulse Iₛₚ is the most important mission criteria or not. If 49(1) yes, process 49 uses 49(2) the commanded Iₛₚ to determine 49(3) applicable limits in operation parameters for lasers 16 & 28, to instigate the corresponding laser ablation operating regime. This information is then relayed 49(4) to sub-process 45(3), the laser control strategy of FIG. 17, for use during HELP thruster 10 activation. The next step involves initiating 49(5) singular thruster control strategy 51 of FIG. 20, which determines the correct HELP thruster 10 response and operation order. This information is then used 49(6) by process 41, HELP thruster 10 operation process of FIG. 4. If 49(1) a high Iₛₚ is not (no) the most important mission criteria, process 49 determines 49(7) if thrust is the most important mission criteria. If 49(7) yes, process 49 uses 49(8) commanded thrust T to determine 49(9) applicable limits in laser operation parameters for lasers 16 & 28, to instigate the corresponding laser ablation operating regime. This information is then relayed 49(10) to sub-process 45(2), the laser control strategy of FIG. 17, for use during HELP thruster activation, and then determines 49(11) whether a single HELP thruster 10 can generate commanded thrust. If 49(11) yes, process 49 initiates 49(12) singular thruster control strategy 51 of FIG. 20, which determines the correct HELP thruster response 10 and operation order. This information is then used 49(13) by process 41, HELP thruster operation process of FIG. 4. If 49(11) no, process 49 initiates 49(14) multiple thruster control strategy 53 of FIG. 26, which determines the correct multi-HELP thruster 130 response and operation order. This information is then used 49(15) by process 41, HELP thruster operation process of FIG. 4.

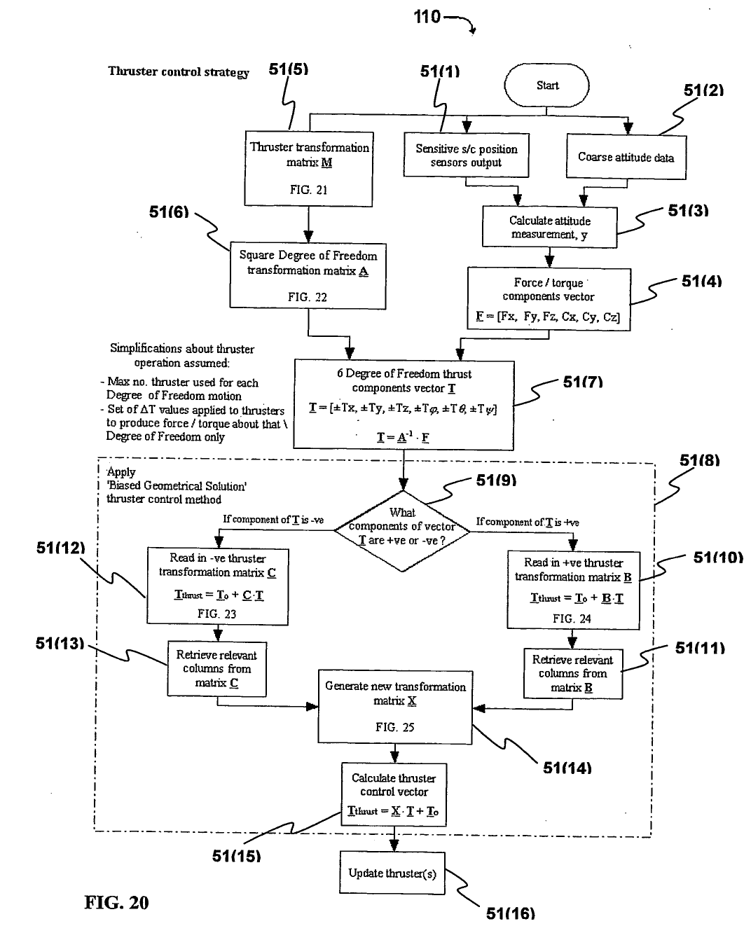

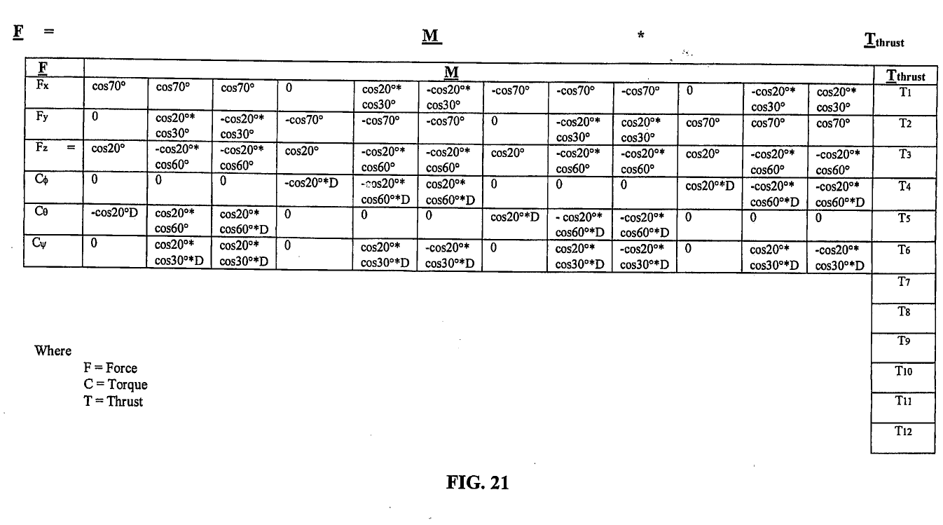

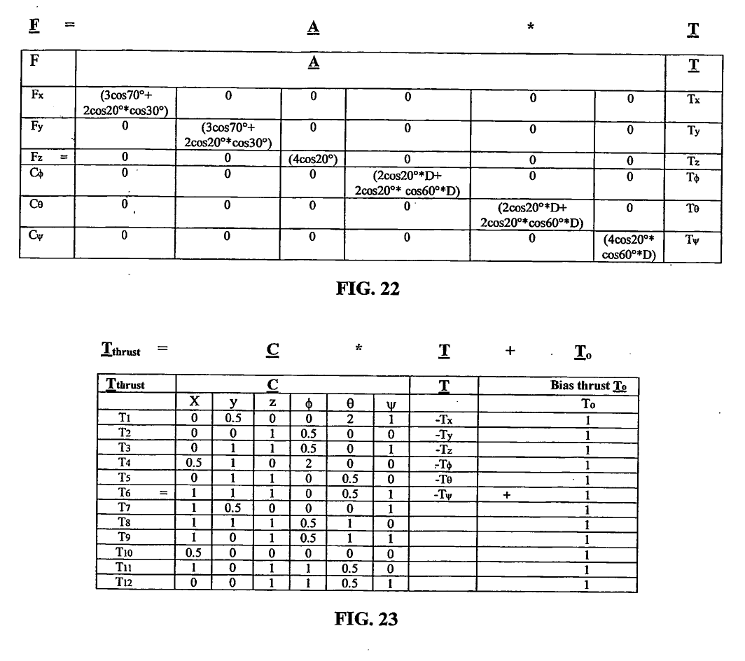

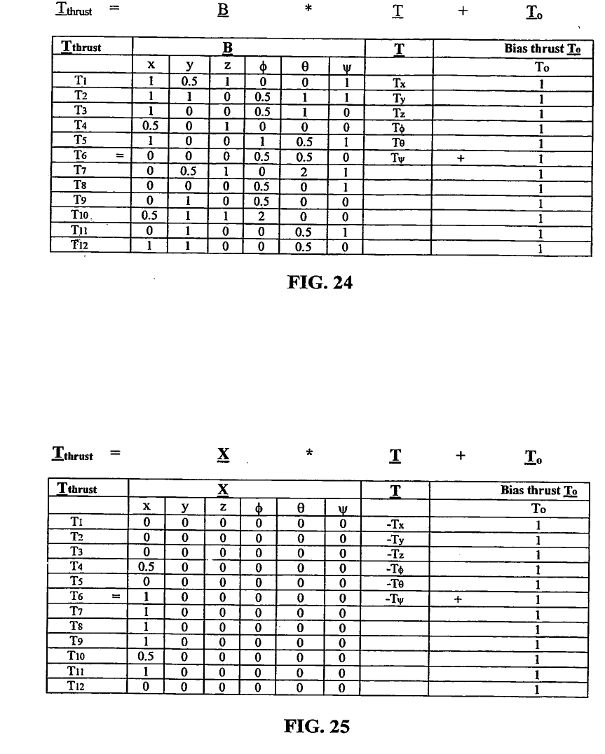

FIG. 20 is a flowchart illustrating an embodiment of a thruster control strategy process 51. As shown, a first step of process 51 involves using the outputs of satellite's sensitive position sensor (51(1)) and coarse attitude data (51(2)) to calculate 51(3) a satellite's attitude measurement y, which is then used to determine 51(4) the force/torque components vector F (F=[Fₓ, F_{y}, F_{z}, Cₓ, C_{y}, C_{z}]) that corresponds to the six degrees of freedom disturbances acting on the satellite. Next, process 51 reads in 51(5) 12×6 thruster transformation matrix M (see FIG. 21, that contains various geometric thrust T component multipliers for each HELP thruster 10 used by satellite) and then converts 51(6) it to a corresponding square (6×6) degree of freedom transformation matrix A (see FIG. 22, that contains combined six degree of freedom geometric thrust component magnitude multipliers accrued from each individual satellite HELP thruster 10). Process 51 then uses matrix A (51(6)) and vector F (51(4)) to calculate 51(7) the corresponding thrust components vector T (T=A⁻¹·F [symbol] T=[±Tₓ, ±T_{y}, ±T_{z}, ±T_{φ}, ±T_{θ}, ±T_{ψ}) to counteract disturbances acting on satellite. Next, process 51 implements a sub-process 51(8) such as a ‘Biased Geometrical Solution’. Sub-process 51(8) entails establishing 51(9) if components of vector T are positive or negative. If positive, sub-process 51(8) advances to reading 51(10) positive thruster component 12×6 transformation matrix B (see FIG. 24); and if HELP thrusters 10 are operated with positive thrust increments ΔT's only, then step 51(10) also calculates 51(10) thruster control vector Tₜₕᵣᵤₛₜ (Tₜₕᵣᵤₛₜ=Tₒ+B·T, where Tₒ is a 12×1 bias thrust vector that corresponds to the nominal operation thrust level of HELP thruster 10 and has the form Tₒ=[1, 1, 1, 1, 1, 1, 1, 1, 1, 1, 1, 1] if all thrusters are working. Accordingly, the bias thrust vector may be multiplied by a factor of n to reflect the chosen nominal thrust level (e.g., if a nominal thrust level of 4 μN is chosen, then n is set to 4). Otherwise sub-process 51(8) retrieves 51(11) relevant columns of matrix B. If negative, subprocess 51(8) advances to 51(12), which involves reading in negative thruster component 12×6 transformation matrix C (see FIG. 23); and if HELP thrusters 10 are operated with negative thrust increments ΔT's only, then step 51(12) also calculates 51(12) thruster control vector Tₜₕᵣᵤₛₜ (Tₜₕᵣᵤₛₜ=T_{ρ}C·T). Otherwise sub-process 51(8) retrieves 51(13) relevant columns of matrix C. Next sub-process 51(8) generates 51(14) a new transformation matrix X (see FIG. 25) using appropriate columns from steps 51(11) and 51(13) and finally calculates 51(15) the thruster control vector Tₜₕᵣᵤₛₜ (Tₜₕᵣᵤₛₜ=X·T+Tₒ) such that a control algorithm for example a proportional integral derivative (PID) control algorithm—may be used to control and update 51(16) HELP thruster(s) 10 to counteract disturbances acting on satellite.

FIG. 26 is a flowchart illustrating an embodiment of a process for controlling a thruster within a multi-HELP thruster 130. As shown, a first step of process 53 involves using outputs of position sensor (53(1)) and coarse attitude data (53(2)) of a satellite to calculate 53(3) attitude measurement y, which is then used to determine 53(4) the force/torque components vector F (F=[Fₓ, F_{y}, F_{z}, Cₓ, C_{y}, C_{z}]) that corresponds to six degrees of freedom disturbances that are acting on satellite. Next, process 53 reads in 53(5) 12×6 thruster transformation matrix M (that contains various geometric thrust T component multipliers for each multi-HELP thruster 130 used by satellite) and then converts 53(6) it to a corresponding square (6×6) degree of freedom transformation matrix A (that contains combined six degree of freedom geometric thrust component magnitude multipliers accrued from each individual satellite multi-HELP thruster 130). Process 53 then uses matrix A (53(6)) and vector F (53(4)) to calculate 53(7) the corresponding thrust components vector T (T=A⁻¹·F [symbol] T=[±Tₓ, ±T_{y}, ±T_{z}, ±T_{φ}, ±T_{θ}, ±T_{χ}) that counteracts disturbances acting on the satellite. Next, process 53 implements a sub-process 53(8)—for example multi-HELP thruster 130 control method such as ‘Biased Geometrical Solution’. Sub-process 53(8) entails establishing 53(9) if components of vector T are positive or negative. If positive, sub-process 53(8) reads 53(10) positive thruster component 12×6 transformation matrix B, and if multi-HELP thrusters 130 are operated with positive thrust increments ΔT's only, then step 53(10) calculates 53(10) thruster control vector T (T=Tₒ+B·T). Otherwise, sub-process 53(8) retrieves 53(11) relevant columns of matrix B. If negative, sub-process 53(8) advances to 53(12), which involves reading in the negative thruster component 12×6 transformation matrix C; and if multi-HELP thrusters 130 are operated with negative thrust increments ΔT's only, then step 53(12) also calculates 53(12) thruster control vector T (T=Tₒ+C·I). Otherwise sub-process 53(8) proceeds to retrieving 53(13) relevant columns of matrix C. Next sub-process 53(8) generates 53(14) a new transformation matrix X using appropriate columns from steps 53(11) and 53(13) and finally calculates 53(15) the thruster control vector Tₜₕᵣᵤₛₜ (Tₜₕᵣᵤₛₜ=X·T+Tₒ) such that a control algorithm—for example a proportional integral derivative (PID) control algorithm—may be used to control and update 53(16) multi-HELP thruster(s) 130 to counteract disturbances acting on satellite.

FIG. 21 to FIG. 25 show examples of various transformation matrices that may be utilized by aforementioned thruster control strategy processes 51 and 53. The transformation matrices shown in FIG. 21 to FIG. 25 correspond to an example thruster configuration case; that is where four clusters of three HELP thrusters 10 are spaced equally apart and are mounted at the midpoint around the circumference of a cylindrical satellite body. Specifically, where the configuration of HELP thrusters 10 within each cluster are arranged axisymmetrically around cluster's main axis, at a 70° angle from normal to satellite's cylindrical surface such that HELP thrusters 10 in each cluster are separated from each other by an angle of 109°. The transformation matrices utilized by multi-HELP thruster 130 control strategy process 53 may be similar to control strategy process 51, except that it involves an extra magnitude multiplier to account for the number of additional HELP thrusters 10 incorporated and aligned together in multi-HELP thruster 130 (as this ganging intuitively increases the various thrust component magnitudes). For different thruster configurations (e.g., thrusters physically distributed in different positions and orientations on the satellite for the aforementioned example) the transformation matrices of FIG. 21 to FIG. 25 are accordingly modified.

Typical criteria that may be used to define the control strategy implemented for given HELP thruster 10 include:
The limitations (if any) introduced by the maximum and minimum thrust levels of HELP thrusters 10. The maximum and minimum thrust levels of HELP thrusters 10 affect satellite design with regards to how many HELP thrusters 10 are required, and how HELP thrusters 10 should be positioned in order to ensure control of satellite in the specified number of degrees of freedom.
The firing of HELP thrusters 10. If HELP thrusters 10 are operated with both a positive and negative or only a positive incremental thrust ΔT, from a nominal thrust level Tₒ—for example, if HELP thrusters 10 are fired with both a positive and negative ΔT (from a nominal thrust level Tₒ), i.e., ΔT>0 and ΔT<0—then a nominal thrust Tₒ may be at least Tₒ=Tₒ+ΔT to provide required range of thrust levels. Where a larger value of Tₒ results in greater consumption of propellant, and therefore a reduction in HELP thrusters 10 lifetime, the method also has an effect on the calculated control authority. The control authority defines the maximum force and moment that HELP thrusters 10 can generate in a given direction, and therefore constrains the selection of the configuration used for HELP thrusters 10 according to mission needs.
The propellant efficiency. The propellant efficiency of selected control method determines duration of mission. Typically, the least amount of propellant is employed when generating control force and moments, where possible,
Computation time. The computation time is ideally short compared with sampling period, to reduce time delay within control loop.

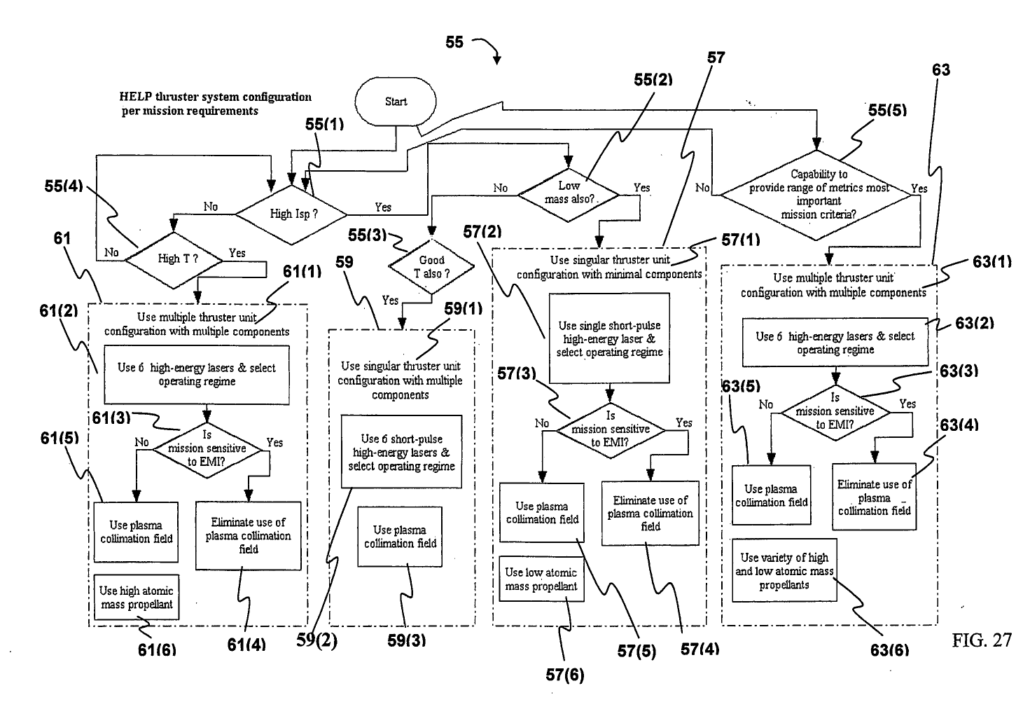

FIG. 27 is a flowchart illustrating an embodiment of a process 55 for determining HELP thruster configuration and propellant choice per mission criteria. As shown, a first step of process 55 involves determining 55(1) if a high specific impulse Iₛₚ is the most important mission criteria or not. If 55(1) yes, process 55 advances to determine 55(2) if a low mass is also an important mission criteria or not. If 55(2) yes, process 55 advances to a sub-process 57, which suggests 57(1) the use of singular HELP thruster 10; that is a configuration with minimal components. Sub-process 57 also suggests 57(2) operating HELP thruster 10 laser 16 & 28 so either the ‘superdetonation’ or ‘ablation dominated’ dynamic behavior laser ablation operating regimes may be instigated. Next sub-process 57 determines 57(3) whether specified mission is EMI (electromagnetic interference) sensitive or not. If 57(3) yes, sub-process 57 suggests 57(4) eliminating the use of plasma collimation field EM_{ν}. If 57(3) specified mission is not sensitive to EMI (no), sub-process 57 suggests 57(5) the use of plasma collimation field EM_{ν}. Sub-process 57 also suggests 57(6) the use of a low atomic mass propellant. If 55(2) low mass is not an important mission criteria (no), then process 55 determines 55(3) if a thrust T is also an important mission criteria, or not. If 55(3) yes, sub-process 59 suggests 59(1) use of a singular HELP thruster 10 but with a configuration that uses multiple components (e.g., a single HELP thruster with 6 lasers 16 & 28). Sub-process 59 may also suggest 59(2) operating lasers 16 & 28 so that either the ‘superdetonation’ or ‘ablation dominated’ dynamic behavior laser ablation operating regimes is instigated. Sub-process 59 also suggests 59(3) the use of plasma collimation field EM_{ν}. If 55(1) a high specific impulse Iₛₚ is not the important mission criteria (no), then process 55 determines 55(4) if a high thrust T is the important mission criteria or not. If 55(4) yes, sub-process 61 suggests the use of multi-HELP thruster 130, with a configuration that employs multiple components per thruster (e.g., a multi-HELP thruster with 6 lasers 16 & 28 per HELP thruster 10 of multi-thruster 130). Sub-process 61 may also suggest 61(2) operating multi-HELP thruster 130 lasers 16 & 28 so the laser supported detonation wave (LSDW) dynamic behavior laser ablation operating regime is instigated. The next step of sub-process 61 determines 61(3) whether the specified mission is EMI sensitive or not. If 61(3) yes, sub-process 61 suggests 61(4) eliminating use of plasma collimation field EM_{ν}. If 61(3) specified mission is not sensitive to EMI (no), sub-process 61 suggests 61(5) use of plasma collimation field EM_{ν}. Sub-process 61 may further suggest 61(6) use of a high atomic mass propellant. If 55(4) a high thrust T is not the important mission criteria (no), then process 55 continues with step 55(1). Process 55 may also determine 55(5) if the capability of providing a range of performance metrics (e.g., a range of specific impulses and a range of thrust values) is the important mission criteria or not. If 55(5) yes, sub-process 63 suggests 63(1) use of multi-HELP thruster 150 in a configuration that uses multiple components (e.g., uses 6 lasers 16 & 28 per HELP thruster 10 of multi-thruster 150). Sub-process 63 may also suggest 63(2) operating multi-HELP thruster 130 lasers 16 & 28 so the laser supported detonation wave (LSDW) dynamic behavior laser ablation operating regime is instigated. The next step of sub-process 63 determines 63(3) whether specified mission is EMI sensitive or not. If 63(3) yes, sub-process 63 suggests 63(4) eliminating use of plasma collimation field EM_{ν}. If 63(3) specified mission is not sensitive to EMI (no), sub-process 63 suggests 63(5) use of plasma collimation field EM_{ν}. Sub-process 63 may also suggest 63(6) use of a variety of high and low atomic mass propellants in multi-HELP thruster 150. If 55(5) the capability of providing a range of performance metrics is not the important mission criteria (no), then process 55 continues with step 55(1).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A hybrid electric-laser propulsion (HELP) thruster, comprising:
a propellant having self-regenerative surface morphology;
a laser for ablating the propellant to create an ionized exhaust plasma that is non-interfering with a trajectory path of expelled ions; and
an electromagnetic field generator for generating an electromagnetic field that defines a thrust vector for the exhaust plasma.

2. The thruster of claim 1, further comprising a controller for implementing control algorithms for controlling the HELP thruster to meet commanded performance.

3. The thruster of claim 1, further comprising a baffle for protecting the laser from contaminants released when the propellant is ablated.

4. The thruster of claim 1, further comprising capillary subsystem for replenishing the propellant.

5. The thruster of claim 4, wherein the propellant is semi-molten during operation of the thruster and wherein the capillary subsystem utilizes surface tension of the semi-molten propellant.

6. The thruster of claim 4, further comprising a propellant gauge sensor for determining an amount of remaining propellant.

7. The thruster of claim 6, wherein voltage applied to capillary ducts of the capillary subsystem generates an electric field, the propellant having a dielectric constant sufficient to sustain the electric field, wherein the propellant gauge sensor measures capacitance of the capillary ducts to determine the amount.

8. The thruster of claim 1, further comprising a propellant housing for protecting the propellant from environmental factors.

9. The thruster of claim 1, further comprising one or more propellant heaters for heating the propellant such that it is in a molten state that enables inflow into capillary feed slots, to feed and replenishment the propellant at a point of ablation

10. The thruster of claim 1, further comprising one or more propellant heaters for heating a surface of the propellant such that the surface is in a semi-molten state, wherein propellant surface tension continually reforms the surface.

11. The thruster of claim 10, further comprising one or more propellant temperature sensors for monitoring temperature of the propellant to ensure that the propellant is not overheated but is maintained in a molten state in the propellant container.

12. The thruster of claim 1, further comprising one or more propellant temperature sensors for monitoring temperature of the propellant, the thruster utilizing the temperature sensors to maintain the propellant in a semi-molten state at a surface of the propellant.

13. The thruster of claim 1, the propellant comprising a wax-based material.

14. The thruster of claim 13, the propellant comprising Paraffin.

15. A multi-hybrid electric-laser propulsion (HELP) thruster, comprising:
a plurality of modular HELP thrusters ganged together to provide cooperative thrust, each of the HELP thrusters having:
a propellant with self-regenerative surface morphology;
a laser for ablating the propellant to create ionized exhaust plasma that is non-interfering with a trajectory path of expelled ions; and
an electromagnetic field generator for generating an electromagnetic field that defines a thrust vector for the exhaust plasma.

16. The multi-HELP thruster of claim 15, further comprising a controller for implementing control algorithms for controlling one or more of the HELP thrusters to meet commanded performance.

17. The multi-HELP thruster of claim 15, each unit further comprising capillary feed means for replenishing the propellant.

18. The multi-HELP thruster of claim 15, each of the HELP thrusters being modular in construction such that any one HELP thruster is replaceable with the multi-HELP thruster.

19. The multi-HELP thruster of claim 15, further comprising interlocking fixtures to connect the HELP thrusters together.

20. The multi-HELP thruster of claim 15, further comprising fiber optic pigtails and electrical bus for ‘plug-and-play’ supply of optical and power signals for the multi-HELP thruster.

21. The multi-HELP thruster of claim 15, the propellant comprising a wax-based material.

22. The multi-HELP thruster of claim 21, the propellant comprising Paraffin.

23. A method of providing thrust propulsion to a spacecraft, comprising:
pulsing laser energy onto a propellant having a self-regenerative surface morphology to ablate the surface and form ionized plasma; and
generating an electromagnetic field to collimate trajectory of the exhaust plasma to provide thrust.

24. The method of claim 23, the propellant comprising a wax-based material.

25. The method of claim 24, the propellant comprising Paraffin.

26. The method of claim 24, further comprising dynamically controlling the thrust during operation of the spacecraft.

27. The method of claim 26, the step of controlling comprising setting an operating regime to one of LSCW, LSCD, superdetonation or ablation dominated.

28. The method of claim 24, further comprising selecting thruster operation, thruster components and configuration, and propellant as a function of spacecraft mission.

29. A method of providing thrust propulsion to a spacecraft, comprising:
pulsing a plurality of lasers onto a plurality of propellants, each propellant having a self-regenerative surface morphology to ablate the surface and form ionized exhaust plasma; and
generating a plurality of electromagnetic fields to collimate trajectory of the exhaust plasmas to provide thrust.
